(19) United States
(12) Patent Application Publication
(10) Pub. No.: US 2008/0104586 A1
(43) Pub. Date: May 1, 2008

(54) Allowing Virtual Machine to Discover Virtual Status Thereof

(75) Inventors: Andrew John Thorton, Seattle, WA (US); Adrian J. Oney, Woodinville, WA (US); Robert H. Earhart, Snohomish, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/553,843

(22) Filed: Oct. 27, 2006

(51) Int. Cl. G06F 9/455

(52) U.S. Cl. 718/1

(57) ABSTRACT

A host computing device has a virtual machine (VM) instantiated thereon. The VM has a virtual application instantiated thereon and a virtual processor. The host also has a virtual machine monitor (VMM) instantiated thereon to oversee the VM and to intercept instructions from a virtual entity comprising one of the virtual application and the VM to the virtual processor of such VM. The virtual entity becomes self-aware of the virtual status thereof based on a self-aware flag as obtained from the VMM, and based thereon obtains particular virtual metadata from a Synthetic range of the virtual processor by way of the VMM to operate efficiently. The Synthetic range of the virtual processor is implemented by the VMM and does not correspond to any defined range of the physical processor corresponding to the virtual processor.

### TECHNICAL FIELD

The present invention relates to a method and mechanism for allowing a virtual machine to discover the virtual status thereof. More particularly, the present invention relates to providing such a method and mechanism so that an instantiated virtual machine or an application instantiated thereon can discover the virtual status thereof. Accordingly, the application or virtual machine can choose to operate in a more efficient manner based on the knowledge of the virtual status thereof.

### BACKGROUND OF THE INVENTION

A virtual machine (‘VM’) is a software construct or the like operating on a computing device or the like (i.e., a ‘host’) for the purpose of providing an emulated machine or system. Typically, although not necessarily, the VM is an application or the like, and may be employed on the host to instantiate a use application or the like while at the same time isolating such use application from such host device or from other applications on such host. In one typical situation, the host can accommodate a plurality of deployed VMs, each VM performing some predetermined function by way of resources available from the host.

Notably, each VM as hosted on a computing device is for all intents and purposes a computing machine, although in virtual form, and thus represents itself as such both to the use application thereof and to the outside world. In fact, one hallmark of a VM is that the VM itself need not be aware of the virtual status thereof, and in a similar manner each use application of the VM also need not be aware of the virtual status of the VM. Thus, and as an example, the VM and/or a use application thereof can and in fact do issue hardware requests for hardware resources of the VM, even though the VM might not in reality have such hardware resources. Instead, and as may be appreciated, such hardware requests are intercepted or otherwise redirected toward the host, and such host services such hardware requests based on the hardware resources thereof, typically with the requesting VM and/or use application thereof being none the wiser.

Typically, although not necessarily, a host deploys each VM thereof in a separate partition, address space, processing area, and/or the like. Such host may include a virtualization layer with a VM monitor or the like that acts as an overseer application or ‘hypervisor’, where the virtualization layer oversees and/or otherwise manages supervisory aspects of each VM of the host, and acts as a possible link between each VM and the outside world. The VM monitor (‘VMM’) may be a separate application running in its own address space or may be integrated more closely with the host operating system, either directly or as an operating system extension of some sort, such as a device driver. Notably, the VMM of the host may intercept or otherwise redirect hardware requests that originate from each VM of the host and/or a use application thereof, and may at least assist in servicing the requests, again with the requesting VM and/or use application thereof being none the wiser.

Although a VM instantiated on a host and each use application of the VM need not be aware of the virtual status of the VM, such unawareness is not necessarily a requirement. In fact, the VM and/or use application thereof can be made aware of the virtual status of the VM without violating typical protocols. Moreover, such self-awareness of such virtual status may be desirable to allow the VM and/or use application thereof to operate more efficiently. Principally, a self-aware VM or a self-aware use application thereof may choose to issue a particular hardware request in a more direct manner based on such self-awareness, and not in a less direct manner that would otherwise be employed. Of course, self-awareness can be employed to achieve other efficiencies.

Note, that a VM or use application thereof (hereinafter, ‘virtual entity’) can become self-aware of the virtual status of the VM thereof, for example by way of an appropriate query to the VMM. However, the VMM has heretofore been unable to convey information to such a self-aware virtual entity via the CPUID instruction to thereby enable more efficient operation. Thus, a method and mechanism are provided to allow a virtual entity to become self-aware by discovering the virtual status of the VM thereof, and based thereon to obtain information from the VMM relevant to such virtual status so that the virtual entity can operate more efficiently.

### SUMMARY OF THE INVENTION

In the present invention, a method and mechanism are provided with regard to a host computing device having a virtual machine (VM) instantiated thereon. The VM has a virtual application instantiated thereon and ostensibly has one or more virtual processors. The host also has a virtual machine monitor (VMM) instantiated thereon to oversee the VM and to intercept CPUID instructions from a virtual entity comprising one of the virtual application and the VM to the virtual processor of such VM. The method allows the virtual entity to become self-aware of the virtual status thereof and to obtain particular virtual metadata based thereon.

In the method, the virtual entity issues a self-aware instruction to obtain a self-aware flag from a defined range of the virtual processor. The defined range of the virtual processor is implemented by the VMM and corresponds to a defined range of a physical processor corresponding to the virtual processor. The VMM intercepts the self-aware instruction to obtain the self-aware flag and returns the self-aware flag as set to the virtual entity.

The virtual entity reviews the set self-aware flag and based thereon becomes self-aware of the virtual status thereof, and also knows that the particular virtual metadata is available from a Synthetic range of the virtual processor. The Synthetic range of the virtual processor is implemented by the VMM and does not correspond to any defined range of the physical processor corresponding to the virtual processor. Thus, the virtual entity issues a metadata query instruction to obtain the particular virtual metadata from the Synthetic range as implemented by the VMM, and the VMM intercepts the metadata query instruction and returns the particular virtual metadata to the virtual entity.

The virtual entity reviews the returned virtual metadata from the Synthetic range and acts based thereon. The virtual entity employs the particular virtual metadata to operate efficiently.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram representing a general purpose computer system in which aspects of the present invention and/or portions thereof may be incorporated;

FIG. 2 is a block diagram showing a computing device acting as a host for a number of virtual machines (VMs), each of which can have a use application instantiated thereon;

FIG. 3 is a block diagram showing leaves of metadata arranged on a processor such as that of the host of FIG. 2 in accordance with embodiments of the present invention; and

FIG. 4 is a flow diagram showing key steps performed in connection with the metadata of FIG. 3 to allow a virtual entity to become self-aware of the virtual status thereof and also to locate virtual metadata in accordance with embodiments of the present invention.

### DETAILED DESCRIPTION OF THE INVENTION

### Computer Environment

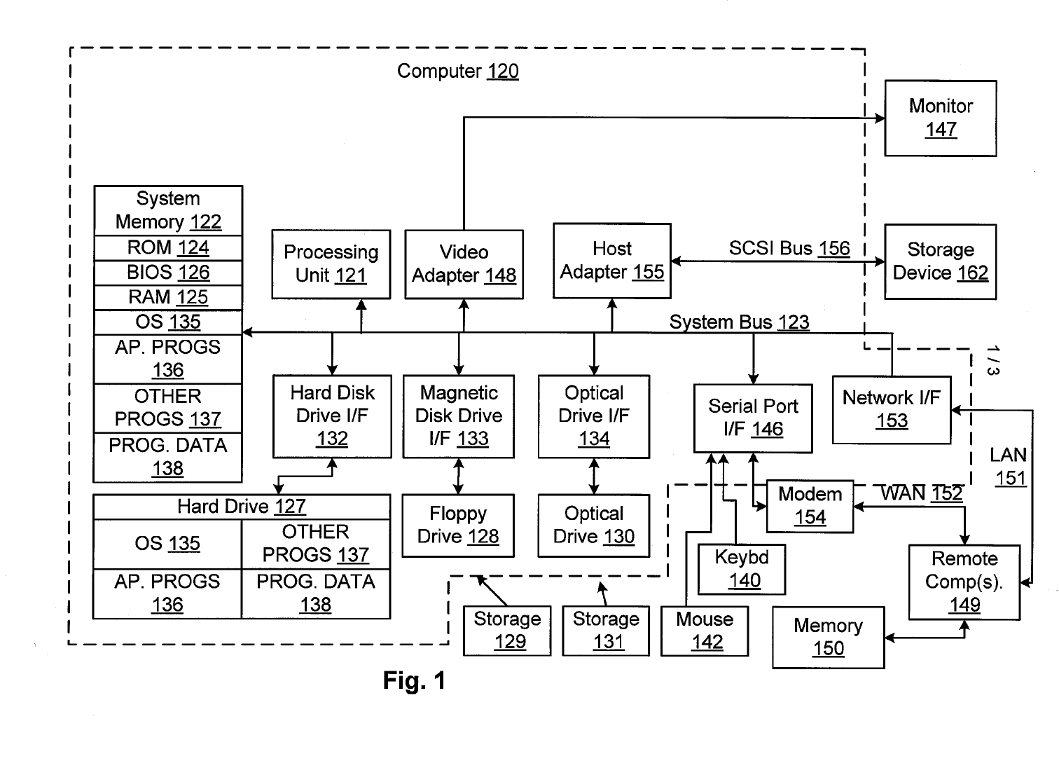

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video/versatile disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

### Hosts and Virtual Machines

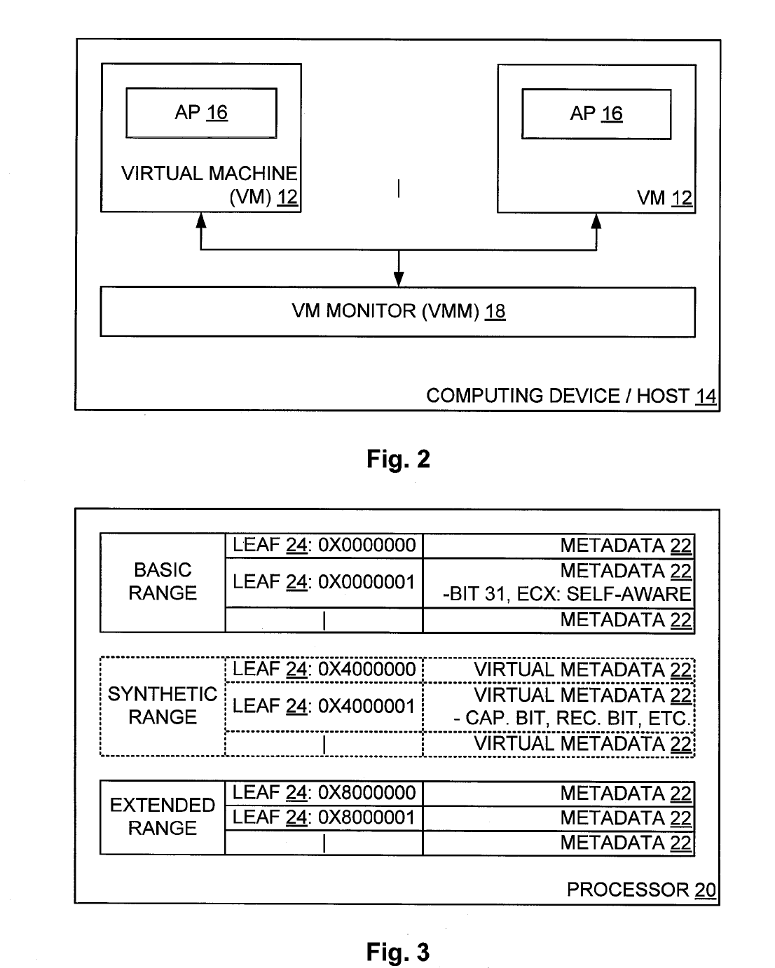

Turning now to FIG. 2, it can be seen that one or more virtual machines (VMs) 12 are deployed on a computing device acting as a host 14 in an appropriate manner. Note here that the VMs 12 and host 14 may be any appropriate VMs and host without departing from the spirit and scope of the present invention. Such VMs 12 and host 14 are known or should be apparent to the relevant public and therefore need not be set forth herein in any detail beyond that which is already provided.

As was set forth above, each VM 12 is a software construct or the like that when deployed on the host 14 provides an emulated machine. Thus, each VM 12 may employ the resources of the host 14 to instantiate thereon one or more use applications 16 or the like. Each VM 12 as instantiated on the host 14 may independently perform some predetermined function. For example, at least some of the VMs 12 deployed on the host 14 may act as data servers, at least some of such VMs 12 may act as network servers with regard to a network (not shown) coupled to the host 14, at least some of such VMs 12 may act as mail servers, and at least some of such VMs 12 may perform low-level functions including maintenance functions, data collection, hardware monitoring, error correction, file management, and the like.

The host 14 itself may be an appropriate computing device such as a desktop computer, a laptop computer, a handheld computer, a data assistant, a mainframe computer, or any other type of computing device with the functionality and capacity necessary to host one or more of the VMs 12. Bearing in mind that each VM 12 may require significant memory, I/O operations, storage space, and processor capacity from the host 14, however, and assuming that the host 14 may be expected to accommodate a significant number of VMs 12 at any one time, the host 14 likely should have significant power and resources to be able to in fact accommodate such VMs 12.

As was set forth above, each VM 12 on the host 14 is for all intents and purposes a computing machine, although in virtual form, and thus represents itself as such both to each use application 16 thereof and to the outside world. In fact, and again, each VM 12 itself need not be aware of the virtual status thereof, and in a similar manner each use application 16 of the VM 12 also need not be aware of the virtual status of the VM 12. Thus, a use application 16 on the VM 12 may for example issue a hardware request for hardware resources even though the VM 12 does not in reality have such hardware resources. Instead, such a hardware request would be intercepted or otherwise redirected toward the host 14, and such host 14 would service such hardware request based on the hardware resources thereof, typically with the VM 12 and use application 16 being none the wiser and otherwise unaware of such redirection.

To effectuate such redirection or the like, the host 14 may include a virtualization layer with a VM monitor 18 or the like that acts as an overseer application or ‘hypervisor’, where the virtualization layer oversees and/or otherwise manages supervisory aspects of each VM 12 of the host 14, and acts as a possible link between each VM 12 and the outside world. As was set forth above, the VM monitor 18 (‘VMM 18’) of the host 14 among other things may intercept or otherwise redirect hardware requests that originate from each VM 12 of the host 14 and/or a use application 16 thereof, and may at least assist in servicing the requests, again with the requesting VM 12 and/or use application 16 thereof (hereinafter, ‘virtual entity’) being none the wiser and otherwise unaware.

### Self-Aware Virtual Entity

Although a virtual entity as instantiated on a host 14 need not be aware of the virtual status of the VM 12 thereof, such unawareness is not a requirement. In fact, and as was pointed out above, a virtual entity if aware of the virtual status of the VM 12 thereof (i.e., a ‘self-aware’ virtual entity) may be desirable to allow the virtual entity to operate more efficiently. Principally, and again, a self-aware virtual entity can make more efficient choices when issuing hardware requests, for example by employing more efficient addressing and/or by routing the requests more efficiently. Such more efficient self-aware choices are known or should be apparent to the relevant public and therefore need not be set forth herein in any detail.

However, inasmuch as a VM 12 represents itself as a real computing machine to each use application 16 thereof and to the outside world, and as was pointed out above, any query from a virtual entity akin to ‘Am I instantiated on a VM 12’ or ‘Am I a VM 12’ would at least theoretically be responded to as ‘No’. Put simply, the VM 12 typically does not in and of itself know that such VM 12 is a virtual construct. Accordingly, a method and mechanism are provided to allow a virtual entity to discover and become self-aware of the virtual status of the VM 12 thereof by way of the VMM 18. Principally, such method and mechanism are rooted in the ability to query a processor for information relating to abilities, manufacturer details, specifications, and the like.

In particular, and turning now to FIG. 3, it is seen that a physical processor 20 of the host 14 or the like may be designed according to an architecture that allows for providing metadata 22 or the like relating such processor 20 upon receiving a processor metadata query or the like. Such provided metadata 22 is generally known or should be apparent to the relevant public and therefore need not be set forth herein in any detail except that which is provided. Typically, such provided metadata 22 specifies details and other information relating to the processor 20, such as for example the manufacturer, the date of manufacture, the operational characteristics, and the like. In fact, such provided metadata 22 may be highly detailed, and can thus be employed by a querying party in a corresponding highly detailed manner.

As but one example of such processor metadata 22, it is known that in the IA-32 instruction set architecture that is typically employed for an INTEL-type processor 20 such as that which would be manufactured and/or marketed by INTEL Corporation of Santa Clara, Calif., a querying party can query for such processor metadata 22 of the processor 20 by executing a processor metadata query known as a ‘CPUID instruction’. In particular, the querying party first loads the EAX register of the processor 20 with a value 24 indicating a particular sub-set of the processor metadata 22 to be returned, where the value 24 is referred to as a ‘leaf’, and the querying party then executes the CPUID instruction.

Such CPUID instruction causes the processor 20 to update the EAX, EBX, ECX, and EDX registers with the processor metadata 22 information associated with the loaded value/leaf 24. For example, executing the CPU ID instruction with EAX set to zero (i.e., requesting the processor metadata associated with leaf value 0) on the aforementioned INTEL-type processor 20 as produced by INTEL Corporation causes the processor 20 to provide processor metadata 22 associated with such leaf value 0 by loading EAX with the input value of the maximum basic CPUID leaf 24 supported by the processor 20, EBX with “Genu”, ECX with “inel”, and EDX with “ntel”.

With regard to the IA-32 architecture in particular, it is known that the CPUID leaves 24 implemented by hardware fall into two ranges: Basic and Extended. The Basic range starts at leaf value 0 and extends for a relatively small number of entries on the order of ten or so, and the Extended range starts at leaf value 0x80000000 and extends for another relatively small number of entries on the order of ten or so. As may be appreciated, the Basic range was originally defined by INTEL Corporation, and was not designed to be extended by third parties. However, when Advanced Micro Devices (AMD) Corporation of Sunnyvale, Calif. began to provide INTEL-type processors 20 with additional capabilities not previously present, AMD defined the Extended range as a place to locate processor metadata relating to such additional capabilities.

At present, then, INTEL conventionally specifies Intel-related processor metadata 22 in the leaves 24 of the Basic range, and AMD conventionally specifies AMD-related processor metadata 22 in the leaves 24 of the Extended range. Notably, there is presently no mechanism available with regard to an INTEL-type processor 20 for inferring the existence of the Extended range beyond checking for processor metadata 22 relating to the manufacturer and processor version, and then checking against a table of processors 20 known to implement the Extended range.

INTEL-type processors 20 as produced by INTEL Corporation support a virtualization architecture known as Virtual Machine Extensions (VMX), and INTEL-type processors 20 as produced by AMD Corporation support a similar virtualization architecture known as Secure Virtual Machine (SVM). As should be understood, each such virtualization architecture enables the aforementioned VMM 18 (FIG. 2) to implement VMs 12. In particular, each VM 12 is capable of instantiating thereon a operating system, sometimes referred to as a guest operating system or guest, in an environment similar to a physical machine, and the VMM 18 of a host 14 is responsible according to the virtualization architecture for making it appear to each guest of the host 14 that such guest is running on a physical hardware machine.

It should be understood that each VM 12 as instantiated ostensibly includes one or more virtual processors 20, where each virtual processor 20 is implemented by the combination of one or more physical processors 20 of the host 14 and the VMM 18. Thus, each virtual processor 20 executes most instructions as a physical processor 20 would, but in a context established by the VMM 18. Of course, no such virtual processors in actuality exist, and accordingly, VMM 18 alters as appropriate the behavior the instructions would exhibit on a physical processor 20. Significantly, certain instructions cause the physical processor 20 to stop executing the guest instruction stream and to return to the VMM 18, which can implement the instructions in software, update the guest state, and then return the physical processor 20 to the guest instruction stream. This is referred to as intercepting an instruction.

In either of the aforementioned virtualization architectures, the VMM 18 can intercept a CPUID instruction/processor metadata query. In so doing, the VMM 18 receives the input value of the requested leaf 24, and can select and even alter the processor metadata 22 which will be returned to the requesting virtual entity. Thus, the VMM 18 can cause the virtual processor 20 of the VM 12 of the requesting virtual entity to appear different from the underlying physical processor 20, such as for example with fewer capabilities or from a different manufacturer.

To implement the ability of a virtual entity to become self-aware, a flag or bit of a particular leaf 24 of the processor metadata 22 is reserved as a ‘self-aware bit’, and the VMM 18 upon receiving a request from a querying virtual entity for the leaf 24 with such self-aware bit can choose to return the self-aware bit in such leaf 24 as set. Thus, with such set self-aware bit, the querying virtual entity can in fact determine the virtual status of the VM 12 thereof. Such self-aware bit may be any appropriate bit in any appropriate leaf without departing from the spirit and scope of the present invention. For example, in connection with the aforementioned IA-32 architecture, such self-aware bit may be bit 31 in the ECX register in response to a processor metadata query with a leaf value set to 1.

Note that such self-aware bit is always returned as cleared by a physical processor 20 in response to a query from a physical entity. That is, a physical entity should never be misled to believe that such physical entity is associated with a VM 12. Note too that a VMM 18 in response to a query from a virtual entity has the option of returning the self-aware bit as set or cleared. That is, the choice is up to the VMM 18, and the VMM 18 may in fact decide for whatever reason to mislead a virtual entity into believe that such virtual entity is associated with a physical machine. Reasons for misleading are known or apparent to the relevant public and therefore need not be set forth herein in any detail. All that said, it follows then that if an entity queries for the self-aware bit and such self-aware bit is returned as set, the entity must be a virtual entity that is associated with a VM 12.

With a virtual entity or the like that can become self-aware by way of a self-aware bit or the like as returned by a VMM 18 or the like in response to an appropriate query, and in one embodiment of the present invention, the VMM 18 may implement an additional synthetic range of leaves 24 by which the VMM 18 can supply virtual metadata 22 to the virtual entity, as is also seen in FIG. 3. In particular, and in addition to the aforementioned Basic and Extended ranges as set forth above, the VMM 18 can implement a Synthetic range, that starts at some predetermined virtual leaf value and extends for some predetermined number of entries.

As should be appreciated, the location and number of entries in the Synthetic range as well as the virtual metadata 22 set forth in the leaves 24 of such Synthetic range may be any appropriate location, number of entries, and virtual metadata 22 without departing from the spirit and scope of the present invention. For example, it may be the case that the Synthetic range is located at 0x40000000 through at most 0x400000FF, and may provide information regarding the capabilities of a virtual processor, as separate from the capabilities of the underlying physical processor 20.

A virtual entity can assume the existence of the Synthetic range only when the self-aware bit is set. Accordingly, if the self-aware bit is not set, the virtual entity or any other entity for that matter must assume that the Synthetic range does not exist. Thus, inasmuch as only the VMM 18 can return the self-aware bit as set, only such VMM 18 can supply virtual metadata 22 from leaves 24 of the Synthetic range.

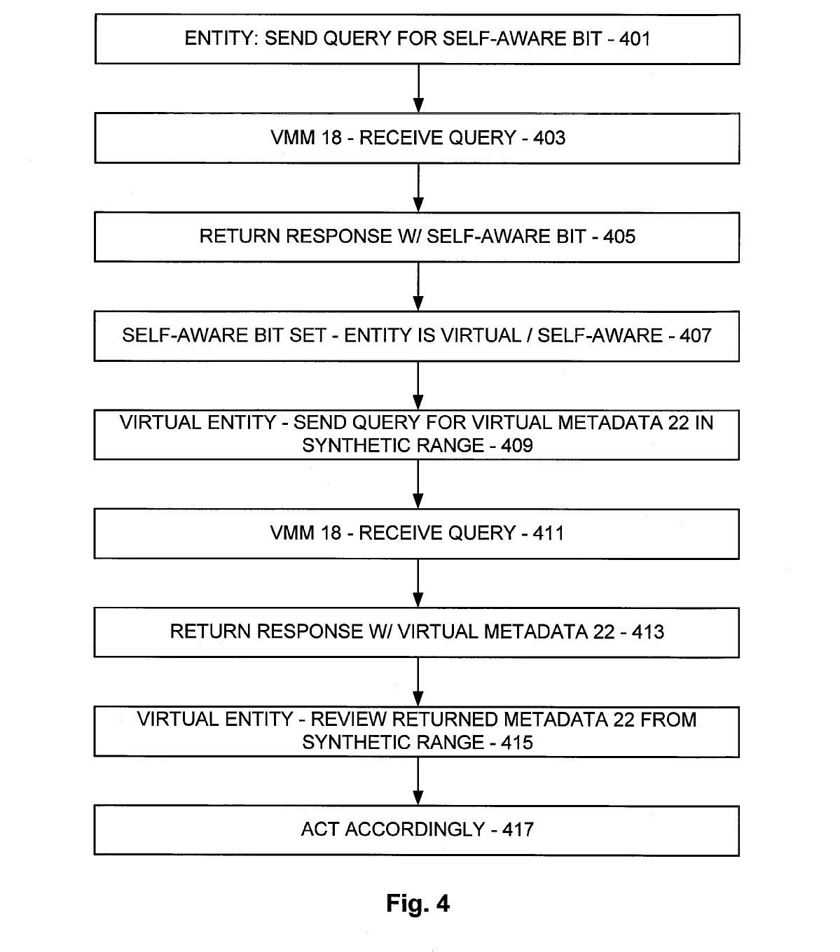

To obtain metadata 22 from a leaf 24 of the Synthetic range, and turning now to FIG. 4, an entity first attempts to become self-aware of the virtual status thereof by sending a query such as for example the aforementioned CPUID instruction query for the self-aware bit at the leaf 24 with value 1 of the Basic range (step 401). Note, though, that the bit may be in another location of the Basic range or in the Extended range. Presuming now that the entity is in fact virtual, the VMM 18 intercepts or otherwise receives the query (step 403) and in response thereto returns a response (step 405) such as for example the aforementioned self-aware bit in the such leaf 24 with value 1.

Presuming that the response of step 405 is in the affirmative, for example by returning the self-aware bit as set, the querying entity reviews the set self-aware bit and based thereon becomes self-aware of the virtual status thereof (step 407). Moreover, the now self-aware virtual entity knows that virtual metadata 22 may be obtained from the VMM 18 by way of the Synthetic range. Accordingly, the virtual entity therefore sends a query for a particular piece of such virtual metadata 22 in the Synthetic range, such as for example by way of another CPUID instruction query for a particular leaf 24 of the Synthetic range with a particular value X (step 409). Once again, the VMM 18 intercepts or otherwise receives the query (step 411) and in response thereto returns a response (step 413) that can be presumed to be the particular metadata 22 at the particular leaf 24 having the particular value X. Thereafter, and as should be understood, the querying virtual entity can review the returned metadata 22 from the Synthetic range (step 415) and act accordingly based thereon (step 417).

As may be appreciated, it may be the case that a self-aware virtual entity as at step 407 is presumed to know how to find particular virtual metadata 22 at a particular leaf X of the Synthetic range. Alternately, it may be the case that the self-aware virtual entity does not know how to find such particular virtual metadata 22 at such particular leaf X of the Synthetic range. In the latter case, it may be useful to include a guide or table of contents or the like within such Synthetic range. Accordingly, it may be the case that the beginning leaves 24 in such Synthetic range, such as 0x40000000 and 0x40000001, are specified to include standard definitions. Thus, a virtual entity upon becoming self-aware as at step 407 first queries for the standard definitions, and based thereon then queries for particular virtual metadata 22 at a particular leaf X of the Synthetic range. Note here that just as a self-aware bit is included in the leaf 24 having value 1 in the Basic range, so too may similar bits be included in the leaf 24 having value 0x40000001 in the Synthetic range.

Note that the Synthetic range as implemented by any particular VMM 18 may contain any particular virtual metadata without departing from the spirit and scope of the present invention. In fact, it is entirely likely if not expected that a first vendor of a first VMM 18 may cause such first VMM 18 to implement a first set of virtual metadata 22 in the Synthetic range thereof, while a second vendor of a second VMM 18 may cause such second VMM 18 to implement a second set of virtual metadata 22 in the Synthetic range thereof, where the first and second sets are slightly or entirely different.

As may be appreciated, the virtual metadata 22 for the VMM 18 in the Synthetic range may contain information beyond that which is typical. For one example, the virtual metadata 22 in the Synthetic range can be employed to specify the capabilities of the VMM 18. That is, rather than just specifying the version and vendor or manufacturer of the VMM 18, the virtual metadata 22 may in addition specify details of the virtual environment implemented by the VMM 18. For example, the virtual metadata 22 may specify support for various synthetic model specific registers (MSRs) and access to various classes of hyper-calls, which are interfaces that can be employed by a virtual entity to control the VMM 18 itself. As alluded to above, the presence of such capabilities virtual metadata 24 may be signified by an appropriate bit being set in the leaf 24 having value 0x40000001 in the Synthetic range.

For another example, the virtual metadata 22 in the Synthetic range can be employed to provide suggestions, hints, and other preferred operating parameters to a querying virtual entity. Such virtual metadata 22 would thus constitute recommendations from the VMM 18 as to how the virtual entity should operate for optimal performance. For example, the VMM 18 might recommend that the virtual entity use a particular call to the VMM to switch virtual address spaces, or might recommend that the guest execute a particular register instruction to switch such virtual address spaces, depending on which mechanism will provide the best performance based on how the VMM 18 implements virtual address space. As before, the presence of such recommendations virtual metadata 24 may be signified by an appropriate bit being set in the leaf 24 having value 0x40000001 in the Synthetic range.

It should be appreciated that although a query from a virtual entity to a VMM 18 for virtual metadata 22 may take the form of a CPUID instruction or some other form, such CPUID instruction provides an advantage in that such CPUID instruction may be employed by unprivileged user-mode code executing in a non-aware (virtual) operating system. That is, if the operating system of a particular VM 12 is for example a legacy operating system that cannot become self-aware, an application 16 (i.e., virtual entity) operating thereon can still become self-aware, presuming such application 16 possesses such self-awareness capability, because such application 16 can still issue a CPUID instruction even when operating on such legacy operating system.

### CONCLUSION

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

In the foregoing description, it can be seen that the present invention comprises a new and useful method and mechanism to allow a virtual entity to discover the virtual status of the VM 12 thereof and thus become self-aware. The virtual entity issues a request that is received by the VMM 18 of the host 14 of such virtual entity, where the VMM 18 can if it so chooses allow the virtual entity to in fact become self-aware, and the virtual entity may then act accordingly by among other things obtaining information from the VMM 18 relevant to such virtual status so that the virtual entity can operate more efficiently.

It should be understood that this invention is not limited to the particular embodiments disclosed, but it is intended to cover modifications within the spirit and scope of the present invention as defined by the appended claims.

1. A method with regard to a host computing device having a virtual machine (VM) instantiated thereon, the VM having a virtual application instantiated thereon and a virtual processor, the host computing device also having a virtual machine monitor (VMM) instantiated thereon to oversee the VM and to intercept instructions from a virtual entity comprising one of the virtual application and the VM to the virtual processor of such VM, the method for allowing the virtual entity to become self-aware of the virtual status thereof and to obtain particular virtual metadata based thereon, comprising the steps of:
the virtual entity determining a defined range of the virtual processor, the defined range of the virtual processor being implemented by the VMM and corresponding to a defined range of a physical processor corresponding to the virtual processor;
the virtual entity determining that particular virtual metadata is available from a Synthetic range of the virtual processor, the Synthetic range of the virtual processor being implemented by the VMM and not corresponding to any defined range of the physical processor corresponding to the virtual processor;
the virtual entity issuing a metadata query instruction to obtain the particular virtual metadata from the Synthetic range as implemented by the VMM;
the VMM intercepting the metadata query instruction to obtain the particular virtual metadata from the Synthetic range of the virtual processor and returning the particular virtual metadata to the virtual entity;
the virtual entity reviewing the returned virtual metadata from the Synthetic range and acting based thereon,
whereby the virtual entity employs the particular virtual metadata to operate efficiently.

2. The method of claim 1 comprising the further steps of:
the virtual entity further issuing a self-aware instruction to obtain a self-aware flag from the defined range of the virtual processor;
the VMM intercepting the self-aware instruction to obtain the self-aware flag and returning the self-aware flag as set to the virtual entity; and
the virtual entity reviewing the set self-aware flag and based thereon becoming self-aware of the virtual status thereof, and further based thereon performing said step of determining that the particular virtual metadata is available from a Synthetic range of the virtual processor.

3. The method of claim 2 wherein each range of the virtual processor is organized as a plurality of leaves, each leaf having particular metadata, the method further comprising the steps of:
the virtual entity issuing the self-aware instruction to obtain a self-aware flag from a leaf of the defined range of the virtual processor;
the VMM intercepting the self-aware instruction and returning the leaf of the defined range with the self-aware flag to the virtual entity;
the virtual entity reviewing the set self-aware flag and based thereon becoming self-aware of the virtual status thereof, and further based thereon knowing that the particular virtual metadata is available from a particular leaf of the Synthetic range of the virtual processor;
the virtual entity issuing the metadata query instruction to obtain the particular leaf of the Synthetic range of the virtual processor with the particular virtual metadata as implemented by the VMM;
the VMM intercepting the metadata query instruction and returning the particular leaf with the particular virtual metadata to the virtual entity;
the virtual entity reviewing the particular virtual metadata from the returned leaf of the Synthetic range and acting based thereon.

4. The method of claim 3 wherein each of the instructions comprises a CPUID instruction based on a value of each corresponding leaf as loaded into a particular register of the virtual processor, and wherein each leaf as returned is found by the virtual entity in one or more particular registers of the virtual processor.

5. The method of claim 1 wherein the Synthetic range of the virtual processor as implemented by the VMM does not correspond to a Basic range or an Extended range of the physical processor corresponding to the virtual processor.

6. The method of claim 1 wherein the particular virtual metadata returned in response to the metadata query instruction comprises a guide to the virtual metadata in the Synthetic range, the method further comprising the steps of:
the virtual entity reviewing the guide and selecting based thereon further particular virtual metadata of interest in the Synthetic range;
the virtual entity issuing a VMM metadata query instruction to obtain the further particular virtual metadata from the Synthetic range as implemented by the VMM;
the VMM intercepting the VMM metadata query instruction to obtain the further particular virtual metadata from the Synthetic range of the virtual processor and returning the further particular virtual metadata to the virtual entity;
the virtual entity reviewing the returned further virtual metadata from the Synthetic range and further acting based thereon.

7. The method of claim 6 wherein the returned further virtual metadata from the Synthetic range comprises metadata setting forth capabilities of the virtual processor as implemented by the VMM.

8. The method of claim 6 wherein the returned further virtual metadata from the Synthetic range comprises metadata setting forth recommendations on how to employ the virtual processor as implemented by the VMM.

9. The method of claim 1 wherein the returned virtual metadata from the Synthetic range comprises metadata setting forth capabilities of the virtual processor as implemented by the VMM.

10. The method of claim 1 wherein the returned virtual metadata from the Synthetic range comprises metadata setting forth recommendations on how to employ the virtual processor as implemented by the VMM.

11. A host computing device having a virtual machine (VM) instantiated thereon, the VM having a virtual application instantiated thereon and a virtual processor, the host also having a virtual machine monitor (VMM) instantiated thereon to oversee the VM and to intercept instructions from a virtual entity comprising one of the virtual application and the VM to the virtual processor of such VM,
the virtual entity determining a defined range of the virtual processor, the defined range of the virtual processor being implemented by the VMM and corresponding to a defined range of a physical processor corresponding to the virtual processor;
the virtual entity determining that the particular virtual metadata is available from a Synthetic range of the virtual processor being implemented by the VMM and not corresponding to any defined range of the physical processor corresponding to the virtual processor;
the virtual entity issuing a metadata query instruction to obtain the particular virtual metadata from the Synthetic range as implemented by the VMM;
the VMM intercepting the metadata query instruction to obtain the particular virtual metadata from the Synthetic range of the virtual processor and returning the particular virtual metadata to the virtual entity;
the virtual entity reviewing the returned virtual metadata from the Synthetic range and acting based thereon,
whereby the virtual entity employs the particular virtual metadata to operate efficiently.

12. The host computing device of claim 11 wherein:
the virtual entity further issues a self-aware instruction to obtain a self-aware flag from the defined range of the virtual processor;
the VMM intercepting the self-aware instruction to obtain the self-aware flag and returning the self-aware flag as set to the virtual entity; and
the virtual entity reviewing the set self-aware flag and based thereon becoming self-aware of the virtual status thereof, and further based thereon performing said step of determining that the particular virtual metadata is available from a Synthetic range of the virtual processor.

13. The host computing device of claim 12 wherein each range of the virtual processor is organized as a plurality of leaves, each leaf having particular metadata,
the virtual entity issuing the self-aware instruction to obtain a self-aware flag from a leaf of the defined range of the virtual processor;
the VMM intercepting the self-aware instruction and returning the leaf of the defined range with the self-aware flag to the virtual entity;
the virtual entity reviewing the set self-aware flag and based thereon becoming self-aware of the virtual status thereof, and further based thereon knowing that the particular virtual metadata is available from a particular leaf of the Synthetic range of the virtual processor;
the virtual entity issuing the metadata query instruction to obtain the particular leaf of the Synthetic range of the virtual processor with the particular virtual metadata as implemented by the VMM;
the VMM intercepting the metadata query instruction and returning the particular leaf with the particular virtual metadata to the virtual entity;
the virtual entity reviewing the particular virtual metadata from the returned leaf of the Synthetic range and acting based thereon.

14. The host computing device of claim 13 wherein each of the instructions comprises a CPUID instruction based on a value of each corresponding leaf as loaded into a particular register of the virtual processor, and wherein each leaf as returned is found by the virtual entity in one or more particular registers of the virtual processor.

15. The host computing device of claim 11 wherein the Synthetic range of the virtual processor as implemented by the VMM does not correspond to a Basic range or an Extended range of the physical processor corresponding to the virtual processor.

16. The host computing device of claim 11 wherein the particular virtual metadata returned in response to the metadata query instruction comprises a guide to the virtual metadata in the Synthetic range,
the virtual entity reviewing the guide and selecting based thereon further particular virtual metadata of interest in the Synthetic range;
the virtual entity issuing a VMM metadata query instruction to obtain the further particular virtual metadata from the Synthetic range as implemented by the VMM;
the VMM intercepting the VMM metadata query instruction to obtain the further particular virtual metadata from the Synthetic range of the virtual processor and returning the further particular virtual metadata to the virtual entity;
the virtual entity reviewing the returned further virtual metadata from the Synthetic range and further acting based thereon.

17. The host computing device of claim 16 wherein the returned further virtual metadata from the Synthetic range comprises metadata setting forth capabilities of the virtual processor as implemented by the VMM.

18. The host computing device of claim 16 wherein the returned further virtual metadata from the Synthetic range comprises metadata setting forth recommendations on how to employ the virtual processor as implemented by the VMM.

19. The host computing device of claim 11 wherein the returned virtual metadata from the Synthetic range comprises metadata setting forth capabilities of the virtual processor as implemented by the VMM.

20. The host computing device of claim 11 wherein the returned virtual metadata from the Synthetic range comprises metadata setting forth recommendations on how to employ the virtual processor as implemented by the VMM.
